(19) United States
(12) Patent Application Publication
(10) Pub. No.: US 2010/0191600 A1
(43) Pub. Date: Jul. 29, 2010

(54) SYSTEM AND METHOD FOR TARGETED AUCTIONING OF AVAILABLE SLOTS IN A DELIVERY NETWORK

(76) Inventor: Gil Sideman, Tenafly, NJ (US)

Correspondence Address: Pearl Cohen Zedek Latzer, LLP, 1500 Broadway, 12th Floor, New York, NY, 10036, US

(21) Appl. No.: 12/376,829

(22) PCT Filed: Aug. 10, 2007
(86) PCT No.: PCT/US07/17802

§ 371 Date: Feb. 9, 2009

Related U.S. Application Data
(60) Provisional application No. 60/836,654, filed on Aug. 10, 2006.

(51) Int. Cl. G06Q 30/00

(52) U.S. Cl. 705/14.53; 705/14.71

(57) ABSTRACT

A system and method is provided for conducting online auctions where customers may use an online interface to compete for available slots in a delivery network that may be used to deliver, customer goods to target users. A system and method is provided for generating and providing customers with predicted data which may relate to the online auctions.

### BACKGROUND

Current markets for certain goods or commodities such as advertisements are imperfect and inefficient. Sales are rarely directed to the needs of individual customers or targeted properly. In auction markets, customers are rarely given sufficient tools to determine how much money to bid to win the goods or commodities of their choice. In dynamic markets, such as advertising, where pricing conditions for creation, sale and delivery of goods or commodities are in constant flux, there are insufficient tools for customers to determine the value of the goods or commodities.

### SUMMARY

A system and method is provided for conducting auctions where customers may use for example an online interface to compete for available slots in a delivery network that may be used to deliver customer goods to target users. A system and method is provided for generating and providing customers with predicted data which may relate to the auctions. A system and method is provided to auction or otherwise distribute goods or commodities, such as advertising.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a schematic illustration of an online auction system, including one or more servers for conducting online auctions, one or more computers or terminals for customers to access and/or compete in online auctions, and one or more computers or terminals for users to view results, in accordance with an embodiment of the invention;

FIG. 2 is a schematic illustration of a web page with a graphical user interface allowing media users to enter information and download streaming media, and its interaction with other components, according to one embodiment of the present invention;

FIG. 3 is a schematic illustration of a web page with a graphical user interface providing customers with customer selection information or parameters for selecting available slots in a delivery system to be bought at auction, and its interaction with other components, according to one embodiment of the present invention;

FIG. 4 is a schematic illustration of a web page with a graphical user interface providing predicted data, and its interaction with other components, according to one embodiment of the present invention;

FIG. 5 is a schematic illustration of a matrix that includes target user ranges, in accordance with an embodiment of the present invention;

FIG. 6 is a schematic illustration of an online auction system, including a host server to compute and store auction data and two or more customer computers that may be used by two or more customers to compete for available slots in a delivery network by bidding in an online auction, in accordance with some embodiments of the invention; and

FIG. 7 is a flowchart of a method according to an embodiment of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, components and circuits have not been described in, detail so as not to obscure the embodiments of the invention.

The processes presented herein are not inherently related to any particular computer or other apparatus. Various general-purpose systems may be used with programs in accordance with the teachings herein, or it may prove convenient to construct a more specialized apparatus to perform embodiments of a method according to embodiments of the present invention. Embodiments of a structure for a variety of these systems appear from the description herein. In addition, embodiments of the present invention are not described with reference to any particular programming language. A variety of programming languages may be used to implement the teachings of the invention as described herein.

Unless specifically stated otherwise, as apparent from the following discussions, throughout the specification discussions utilizing terms such as “processing,” “computing,” “calculating,” “determining,” or the like, refer to the action and/or processes of a computer or workstation, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention relate to auctions, conducting auctions, generating auction simulations, generating simulated and or predicted data that relates to conducting auctions and providing or displaying such auctions and data. Customers may have an option to take part in an auction, for example, by bidding to win one or more entities, goods or commodities to be sold at auction such as available slots in a delivery network or opportunities to send advertisements to listeners or viewers of programming or streaming media. A slot may be, for example, a specific space within a broadcast in which an advertisement is placed.

Available slots in a delivery network may be auctioned or allocated to customers. For example, advertisements may be auctioned to be delivered during slots or advertisement pods, for example, in streaming media directed or targeted at specific users described by parameters selected by customers. Customers may select parameters that describe a group or subset of slots targeted at a group or subset of users.

Customers may compete in a series of auctions to be allocated one or more available slots during a broadcast. In one embodiment, instead of selecting specific slots in a broadcast, the customer may select a set of parameters that describe a broadcast in general. However, the customer may be allocated one or more specific slots in the broadcast, for example, based on the results of the auction, that may be delivered to a target user in a specific position during the broadcast (e.g., in a specific advertisement pod or space in a broadcast where advertisements may be inserted).

A delivery network may include components that may send (e.g., a host server or a media server), store (e.g., a local user computer, a media player advertisement agent that may include supporting software for such storage entities), broadcast (e.g., a media server) or display (e.g., a media GUI or a display) client goods (e.g., advertisements) to users. For example, an online radio delivery network may include an online radio broadcast server, a radio broadcast player with an integrated advertisement agent, and a user computer to display or play client advertisements.

Users viewing or listening to programming may identify or categorize themselves, for example, by disclosing personal or demographical information. Customer advertisements may be broadcast to users who fit target user information which the customer chooses. Such users may be exposed to streaming media, for example, via a media graphical user interface (GUI), including advertisement spots according to the results of auctions.

### General System

In one embodiment, goods or commodities such as available slots in a delivery network may be auctioned. The available slots may be for example, advertisement slots for customer advertisements, for example, that may be integrated or inserted into streaming media. A user may view the customer advertisements, which may be integrated with streaming media, for example, using a display such as a media GUI. In other embodiments, any suitable entities, goods or commodities may be sold via an auction, for example, the rights, services and/or use of goods or advertising space, or resources; for example, the use of billboard space, access to telephone, television or computer network services, remote network or server space, or cargo slots to deliver goods such as on a freight train or shipping vessel.

Embodiments of the present invention relate to conducting an auction for available slots in a delivery network for broadcasting advertisements to target users, where a target user may access the advertisement broadcast. Available slots in a delivery network may be, for example, added to or integrated into, and utilized in, display contexts, such as streaming media, wireless and Internet-based devices, interactive TV, web sites and other applications.

In one embodiment of the present invention, a streaming media system is presented, where the available slots constitute potential advertising time segments. A method or system may allow a customer to compete or participate in an auction for these slots by selecting a set of parameters describing desired advertisement slots. Parameters may include, for example, target user demographics and/or target usage data (e.g., when a user accesses a media stream or to which streams a user views or listens). The customer may select a set of parameters that may describe a subset of desired advertisement slots from a set of desired advertisement slots, for example, which may include all available slots in a delivery network that the customer may purchase at auction.

Customers may participate in one or more auctions that may or may not overlap in time and may or may not involve the same advertisement slots. For example, the auctions in which a customer competes may depend on the customer's selection of parameters or options, which may define the subset of desired advertisement slots for which the customer competes at auction.

Each customer may select a set of parameters that may define a subset of desired advertisement slots or other goods. A system may conduct an auction or series of auctions and may accept a first set of parameters from a first customer, a second set of parameters from a second customer and may accept other sets of parameters selected by other customers. A series of available slots in a delivery network described by the set of parameters may be auctioned. If the first customer and the second customer select sets of parameters that describe overlapping and available slots in a delivery network, the customers may compete in an auction for those available slots.

In one embodiment, the system may conduct an auction for available advertisement slots in radio programs or other audio (or video) that may be delivered or distributed in a delivery network, e.g., using a network such as the Internet and via an online radio player. Customers may specify a group, type or demographic of desired target users to whom the advertisements may be made available, by selecting sets of target user parameters. Customers may bid on a group or range of slots in a delivery network that may be directed, selectively delivered or available to target users. A host server may compile such information and conduct a series of auctions. The host server may generate or assemble a series of customer advertisement sequences that may be delivered to appropriate target users. Customers who win or who hid substantially competitive prices at auction may have their advertisements delivered in a delivery network to a target user only if the target user accesses the radio player.

Client side interfaces, for example, customer GUIs, may facilitate customer processes, such as selecting parameters or bidding, for example, by providing customers with predicted data that may relate to the auction, for example, predicted bid prices allowing a customer to obtain an advertisement slot for a target group of users. In one embodiment, the host server may distribute predicted data in a fair and consistent manner, such that all customers may be provided with the same type of predicted data, so that no user may be given an advantage (e.g., given more or more accurate information) over another user.

In one embodiment, predicted data may be based on simulated data and/or data recorded from auctions conducted at another period in time. The information may or may not match actual auction results.

Successful sales, appropriations or allocations of slots directed at a particular set of target parameters may depend on a customer's bid price, and in addition on competing customer bids, the nature or availability of the advertisement slots in a delivery system or other factors, for example, advertisement length, advertisement components (e.g., if advertisement includes music, text, video, etc.), broadcast times, and media type (e.g., Internet radio, Internet television, terrestrial media, etc.). For example, if less than an expected number of target users download or access a media stream, a customer may be allocated fewer advertisement slots than predicted for the customer bid price.

As a result of an allocation or auction, available advertisements or advertisement sequences may be delivered to multiple destinations, for example, to customer GUIs (e.g., to report auction results), to user GUIs (to deliver or broadcast advertisements to target users according to auction results) or other suitable destinations.

Customers may have the ability to bid on specific available slots in a delivery system, and in addition on a subset or range of available slots in a delivery system, for example, a range of advertisement slots, which may include a range of broadcast programs, times, etc. For example, a customer may bid to deliver advertisements to users in a certain demographic listening to a set of radio programs. Other customers may bid for different or overlapping demographic and usage subsets—where the subsets overlap, competitive bidding may occur. A customer may win an auction if it wins any of the available slots in the selected subset. For example, a customer may win an auction if the customer's advertisement is broadcast to any of the selected demographic and usage ranges for which the customer bids.

Customers who bid competitive prices may have their advertisements delivered to a larger percentage of target users than other customers who intended to reach the same target users but bid less competitively. In one embodiment, the customer with the highest bid may win available slots in a delivery system with the highest priority or value within the selected range or subset of available slots sold at auction. Higher priority slots may be, for example, slots more likely to be listened to than lower priority slots, due to the nature of a user GUI, and the highest priority slot may, for example, be a slot presented in a prime position, for example before a media stream starts. For example, the customer advertisement with the highest bid may be broadcast in the first available advertisement time slot for a broadcast. A customer may win more or less of a large number of available slots by bidding more or less. In one embodiment, a customer may win an available advertisement slot in a delivery system if the customer's advertisement may potentially be delivered to a target user. In another embodiment, a customer may win an advertisement slot only if the customer advertisement is actually broadcast to a target user. Typically customers are only charged for advertisements that are broadcast to target users.

### System Overview

According to some embodiments of the present invention, auctions may be conducted using one or more servers. Host servers may generate client side interfaces, determine auction results, facilitate customer processes (e.g., record or generate information for the customer such as predicted data) and provide a GUI for customers, for example, via client side interfaces.

Auction results may include, for example, which customers have won advertisement slots in a series of auctions and with what priority each customer has won, for example, which advertisement slots may be allocated to each customer. An auction may include a series of independent or overlapping auctions that may be conducted (e.g., in real time) every or substantially every time a good, commodity or unit such as an advertisement slot may be available to be allocated to a customer. A customer in such a series of auctions with a relatively higher bid may be allocated a relatively larger or more valuable portion of a subset of units or advertisement slots that are available at auction. This may result, for example, from that customer's advertisements being presented to a user earlier in a media stream; if a user stops listening lower ranked advertisements are not presented. An auction may result in a series of individually priced allocations of advertisement slots targeted at individual users. In an embodiment that includes customers bidding on available slots in a delivery system to be delivered to a range of target users, host servers may compile auction results and may generate or assemble an advertisement sequence that may be integrated into a media broadcast directed or available to target users. An advertisement sequence may include all advertisements that may be delivered to a target user by a delivery network in available advertisement slots of the delivery network (e.g., in order of delivery). For example, if the delivery network delivers streaming media, the advertisement sequence may include all advertisements that may be delivered to a target user during the duration of a broadcast program. A customer with the higher bid relative to another may be allocated an advertisement slot with greater priority in placement, frequency or arrangement, relative to another.

### System Details

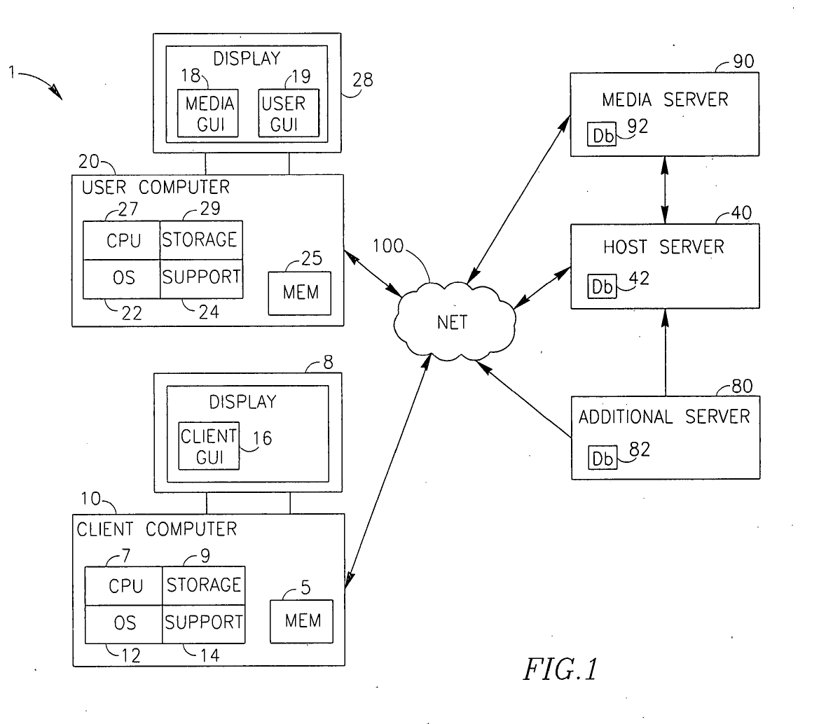

FIG. 1 schematically illustrates an online auction system, including one or more servers for conducting online auctions, one or more computers or terminals for customers to access and/or compete in online auctions, and one or more computers or terminals for users to view auction results, in accordance with an embodiment of the invention. An online auction system 1 may include a host server 40 that may conduct online auctions, for example, through one or more communications networks such as Internet 100.

In one embodiment, host server 40 may conduct an online auction for customers to bid for available advertisement slots in a delivery system, for example, streaming media sources, that may be delivered to target users. Host server 40 may include interactive (e.g., two-way) connections, for example, via Internet 100, with users, via one or more local computers 20, customers, via one or more local computers 10, media sources, via one or more media servers 90 and any other suitable systems or components. Host server 40, media server 90 and additional servers 80, may include databases 42, 92, and 82, respectively. In one embodiment, host server 40 may access media server 90 and/or additional server 80. Servers, computers or systems may access host server 40, media server 90 and additional servers 80 directly or indirectly, via networks such as Internet 100 using wireless or hardwired connections.

Host server 40 may generate and support client side interfaces, for example, a customer GUI 16. Host server 40 or another server may generate and support user side interfaces, for example, a user GUI 19, that may include, for example, accepting disclosed user information such as demographic or personal information. Host server 40 may have two-way connections such that host server 40 may read input and write output, for example, from and to local computers 10 and 20 via customer GUI 16 and user GUI 19, respectively, using Internet 100.

Local computer 10 may be accessed or used by a customer. Local computer 10 may include a memory 5, a processor 7, a monitor or output device 8, a mass storage device 9, an operating system 12 and supporting software 14 (e.g., Internet support software or other suitable software) and may operate a customer GUI 16. Monitor or output device 8 may display customer GUI 16. A customer may participate or compete in an auction, using customer GUI 16. Local computer 10 may include other components and capabilities.

Local computer 20 may be accessed or used by a user. Local computer 20 may include a memory 25, a processor 27, a monitor or output device 28, a mass storage device 29, an operating system 22 and supporting software 24 and may operate a media GUI 18 and an optional user GUI 19. Supporting software 24 may include, for example, Internet support software for displaying user GUI 19, for example, via a web page. Supporting software 24 may include, for example media support software for displaying media GUI 18, for example, streaming media player, or other suitable software. Monitor or output device 28 may display media GUI 18 and optional user GUI 19. Local computer 20 may include other components and capabilities.

System 1 may provide customer GUI 16 using host server 40, media GUI 18 using Media server 90 and optional user GUI 19 using host server 40 and/or other suitable servers.

In one embodiment, customers or users may have individual, personal or private accounts, which may include reports or histories that may be stored on host server 40. For example, a customer's auction history, advertisement campaign financial statements, previously created advertisements, etc., may be stored for the customer, in such an account. Account information may be displayed for customers or users via customer GUI 16 or user GUI 19, respectively. In one embodiment, accounts may be accessed by codes, passwords, serial numbers or any other suitable forms of identification. Customer GUI 16 may be specifically designed or modified for the customer based on the customer's past auction history.

### User GUI

In one embodiment, users may view, hear or otherwise be exposed to customer advertisements, for example, integrated into streaming media, via Media GUI 18. Media GUI 18 may include, for example, a radio or television player to play radio or television programs. Other media GUIs and other types of streaming media may be used. Media GUI 18 may be a local or remote program, served or provided by media server 90. Media GUI 18 may be accessed by local computer 20 and served by media server 90. Streaming media may include for example customer advertisements or an advertisement sequence integrated into available slots of streaming media by a delivery network that may be assembled as a result of a series of auctions. The advertisement sequence may be generated, for example, in accordance with the results of the auction by host server 40.

The appropriate advertisements may be stored, for example, in a cache unit or other area on user computer 20, prior to when the advertisements are broadcast. A media stream may include one or more advertisement pods. An advertisement pod may be a space within a media stream or broadcast during which an advertisement may be played. A broadcast or media stream output by a media GUI 18 may include a fixed number of advertisement pods that may be of fixed length and may include a number of available slots that may be allocated at auction. For example, a broadcast may have a three minute advertisement pod every twelve minutes. The number of available slots or advertisement pods during a broadcast may be different for each broadcast.

In one embodiment, a broadcast or media stream may include indicators that may indicate when an advertisement pod is accessed or viewed. When such an indication or signal is received, the appropriate advertisements may be retrieved (e.g., by an advertising agent) from storage (e.g., from a cache unit) and inserted or integrated into the advertisement pod.

When a gap or advertisement pod appears in a media stream, a set of advertisements from an advertisement sequence may be output by media GUI 18, in order. The next advertisement pod in the media stream may be filled with a next set of advertisements in the advertisement sequence. In such a manner, the first advertisement in the sequence is more likely to be exposed to a user (e.g., who may only listen for a certain amount of time then the second, and so on. The advertisement sequence may include customer advertisements from all customers that won the auction, ordered by bid price.

Media GUI 18 may display or play streaming media broadcasts with integrated customer advertisements. Media broadcasts may be provided, for example, by media server 90 or other sources and customer advertisements may be provided by, for example, host server 40. If a customer wins a set of available advertisement slots in a series of auctions, the delivery network may broadcast the customer's advertisement (e.g., to target users) in the slot or pods the customer was allocated in the auctions. The delivery network may include for example host server 40, media server 90, user computer 20, media GUI 18 or other components of system 1 that may deliver a customer advertisement to a target user. In one embodiment, users may disclose user information, such as personal, demographic or other information, that may be recorded, stored or used in an auction, for example, by host server 40. For example, in order to gain rights to view the streaming media, users may be required to identify or describe themselves by disclosing user information, for example, using user GUI 19. User information may include, for example, location, (e.g., address, state, zip or postal code) sex, income level, age, or other demographic or personal information. User information may be stored in a database 42 in host server 40. In one embodiment, a user's information may be stored in a user account in database 42 of host server 40 and may be accessed by a user via user GUI 19 or media GUI 18.

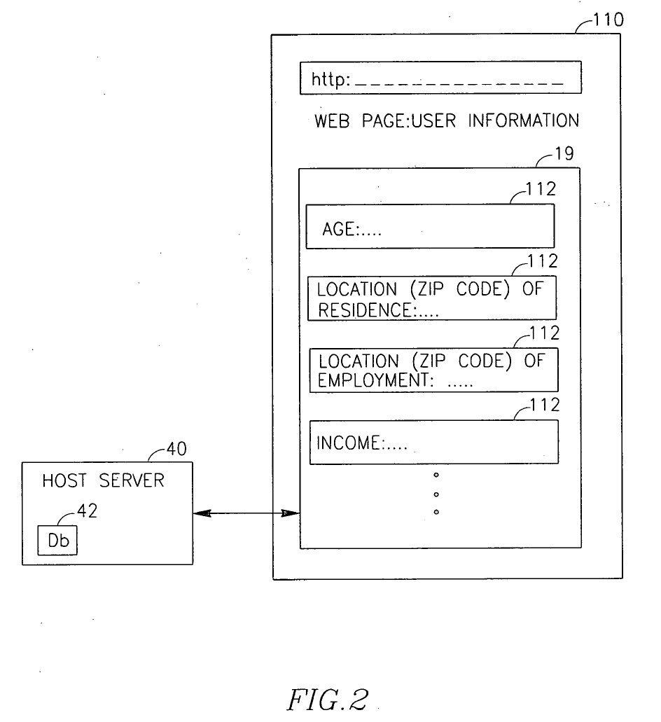

FIG. 2 schematically illustrates a web page with a graphical user interface allowing media users to enter information and download streaming media, and its interaction with other components, according to one embodiment of the present invention. A user may, for example, enter information into user information fields 112 provided by host server 40 via user GUI 19. In one embodiment, user information fields 112 may be displayed on one or more user GUI 19 screens that may be viewed on one or more of web pages 110.

In one embodiment, users may enter information from among user information fields 112 provided by user GUI 19. User information fields 112 may include, for example, demographics, location of residence and/or employment, zip code, age, income level and any other suitable user information. User usage information may also include additional user information fields 114 that are not explicitly disclosed or selected by the user, such as, radio stations selected, and times of use, the time a user is operating a streaming media GUI 18, the type of streaming media requested, the user's most frequently viewed or listened to programs or the times of day the user listens to or views programs. Such user information fields 114 may be used to select and/or auction advertisements to send to a user by, for example, inserting the advertisements in a media stream. Such user information may be used to allow a customer to select a subset of users and bid for the opportunity to present the subset of users with advertisements. Undisclosed additional user information fields 114 may be recorded, for example, using cookies, as is known in the art.

In one embodiment, users may only be presented with or view advertisements if the information the user enters into user information fields 112 and additional usage information fields 114 meet target user criteria. Advertisement to be placed in slots in a delivery network may be delivered to users who disclose information that falls within the client's target user range.

### Customer GUI

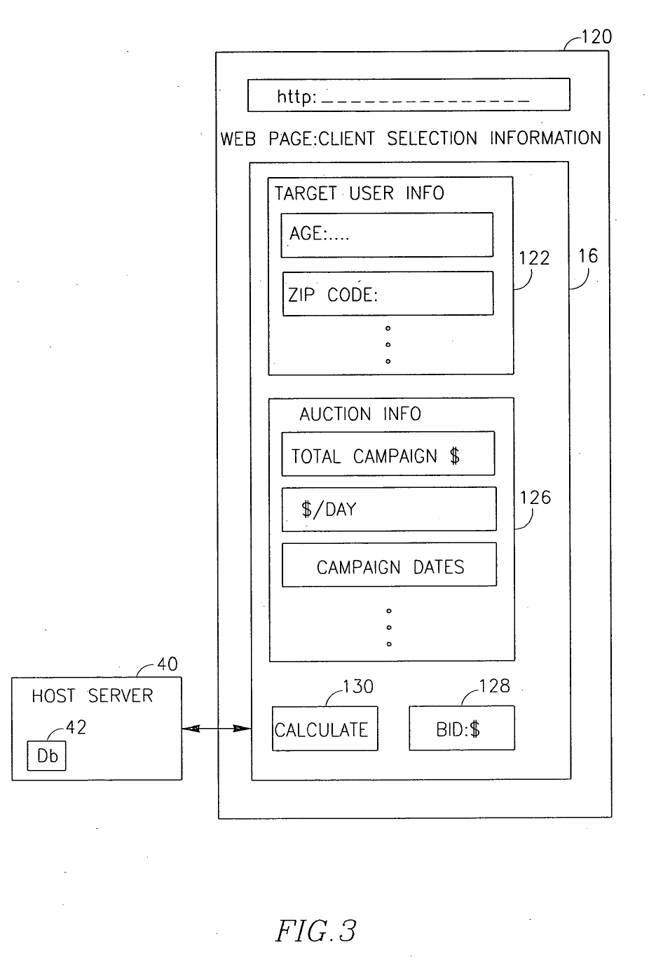

FIG. 3 schematically illustrates a web page with a graphical user interface providing customers with customer selection information or parameters for selecting available slots in a delivery network to be bought at auction, and its interaction with other components, according to one embodiment of the present invention. Customer selection information fields 125 may include target user information 122, for example, target user demographics (e.g., set of potential users to which customer advertisements may be delivered), usage information (e.g., when users are downloading media or what type of media is downloaded), and auction information (e.g., bid prices to compete at auction for the ability to deliver advertisements to a subset of users who enter user information that falls within the range of selected targeting user information).

An auction may include or result in a series of individually priced allocations of a set of available slots in a delivery network. A delivery network may deliver customer advertisements in the available slots (e.g., in streaming media via media GUI 18) to target users according to the results of the auction. For example, each time an advertisement is to be delivered (e.g., when a media GUI 18 indicates to host server 40 that an advertisement slot is available within a media stream), the information corresponding to the user operating the media GUI 18 may be used to determine what advertisements to deliver to the media GUI 18. The appropriate advertisements may be stored, for example, in a user computer 20, prior to when the advertisements are broadcast.

In one embodiment, all customers that request that an advertisement be delivered to a range of target users having certain usage information, for example, by selecting customer selection information including target user information 122, may enter a series of auctions that sell advertisements that may be delivered to appropriate users. In one embodiment, if a targeted user accesses a media GUI 18 broadcast at the time an advertisement slot is sold at auction, a customer advertisement targeted at that user, may be delivered to the user. Customers with the highest bids may have their advertisement delivered or available to members of the group of targeted users, for example, the advertisements may be transmitted to the targeted user's media GUI 18 in an available slot. This may be achieved on a case by case basis, or for example by delivering or creating one overall advertising sequence, and inserting portions of the sequence into slots or gaps in the media stream as they occur. Advertisement slots further along in the sequence may correspond to lower bids, and therefore higher a bid may result in an advertisement more likely to be viewed or heard.

In one embodiment, host server 40 may accept two or more bids (e.g., from customers). Each bid may correspond to an advertising campaign. For example, each bid may correspond to a set of user parameters, (e.g., that may describe one or more target users) and an advertisement. In one embodiment, an advertisement sequence may be created for each user. Each advertisement in the advertisement sequence may correspond to a set of user parameters describing the user and the user's usage (e.g., when the user listens, and to what). The advertisement sequence may be ordered by the amount of the bids corresponding to the advertisements and/or other factors. Advertisements may be distributed, for example, in available slots in a delivery network of a media stream, to a plurality of users that receive media streams. In one embodiment, host server 40 may transmit advertisements to users. Host server may only transmit to users advertisements which correspond to a set of user parameters describing the user. Advertisements corresponding to higher bid prices May be transmitted or placed in an advertisement sequence earlier than advertisements corresponding to lower bid process.

In one embodiment, an advertisement sequence or a portion of a sequence directed at a target user may be integrated into a streaming media broadcast when the target user tunes into the broadcast. Thus, if the user tunes in for a middle portion of the broadcast, the user may view a beginning portion of the advertisement sequence. Thus, a customer with the highest bid, whose advertisement is typically placed first in the advertisement sequence, may be allocated the first advertisement slot that a user views, regardless of when the user tunes in or stops listening. In another embodiment, an advertisement sequence directed at a target user may be integrated in full into a streaming media broadcast in available slots or advertisement pods in the broadcast. Thus, if the user tunes in for a middle portion of the broadcast, the user may view a middle portion of the advertisement sequence.

Customers may compete for a desired advertisement slot by selecting a set of customer selection information fields 125 that may describe a subset of available slots or pods in a delivery network that the customer may compete for at auction. Customer selection information fields 125 may be selected for example using web page 120 via customer GUI 16 and may be stored in database 42 of host server 40. Host server 40 may provide customers with customer selection information fields 125, via customer GUI 16 via Internet 100. Customer selection information fields 125 may be displayed on one or more customer GUI 16 screens that may be viewed on one or more web pages 120.

Customer selection information fields 125 may include, for example, auction information 126, target user information 122, and any other suitable information. The customer may select from one or more target user information 122. For example, target user information 122 may include desired demographics, locations of residence (e.g., expressed as a zip or postal code) and/or employment, family histories, or any other suitable desired target user information. In addition, target user information 122 may include a desired number of exposed target users, and usage information such as the time or time window of a broadcast, and the type of broadcast station and/or program (e.g., talk radio, sports, etc.). Typically target user information 122 may correspond to user information fields 112 and additional user information field 114, for example, age, location of residence and/or employment, and usage information such as the program, channel (or type of program or channel) and time the user must view a broadcast for an advertisement to be delivered to the user.

In one embodiment, if a customer selects a set of user parameters that overlap, host sever 40 may calculate appropriate and corresponding non-overlapping target user selections. For example, if a customer selects age range: 12-18 and age range: 17-20, host server 40 may replace the customer selections with age range: 12-20. The customer may bid at auction on available advertisement pods or slots within a desired broadcast where advertisements may be delivered to the corresponding group of non-overlapping target users, and will not compete in overlapping or repetitive auctions.

In one embodiment, the customer may control or create the content and design of the advertisement that is played in an available advertisement slot won at auction by, for example, selecting an advertisement creation option 124. The customer may be presented with tools to create or upload an advertisement. Tools may include, for example, selecting the type(s) of streaming media via which the customer advertisement may be broadcast, (e.g., internet radio, internet television, terrestrial media, etc.) advertisement format and content, (e.g., only text, streaming banner, audio and/or visual with optional text, images or image streams, text-to speech technology, etc., one or more music tracks and/or one or more jingle/sound effect tracks with variable play time, volume, etc.). In another embodiment, the customer may use customer computer 10, to upload or access advertisements or advertisement tools from database 42 or from another suitable source, for example, computer memory 5, additional server 80 and/or an external device, such as, a music or audio storage device. Advertisement size may affect auction/bid price per advertisement exposure. Customer advertisements may be stored in, for example, database 42 or host server 40. In one embodiment, customer advertisements may be accessed by system 1 by a reference number or by a customer account number. In one embodiment, customer advertisements may be subject to approval, for example, in accordance with FCC regulations or other standards, before the advertisement may, be broadcast or before a customer may enter auction to bid for deliveries of the advertisement.

### Overview of Auction

A customer may specify or select from among available pods or slots in a desired broadcast (e.g., by selecting parameters that describe the broadcast), which may be bid on at auction. The customer may select or enter auction information 126, which may include, for example, potential customer bid prices or ranges of bid prices, including a minimum and/or maximum bid price for each advertisement broadcast to a target user, cost of advertisement campaign per period of time, total cost of advertisement campaign, campaign duration, etc. Host server 40 may input auction information 126 and output predicted data 135. Predicted data 135 may be based on, for example, customer selection information fields 125. Based on predicted data 135, the customer may choose to adjust selected auction information 126. The customer may verify the selected auction information 126, for example, by selecting a bid command 128 that may be displayed on customer GUI 16. In one embodiment, the customer may select a bid price from among auction options 126 provided by customer GUI 16 or the customer may generate a monetary amount.

Prior to accepting a bid at auction, system 1 may require proof of payment or actual payment. For example, the user may be required to disclose credit or specific credit card information that may be stored in database 42 of host server 40. System 1 may verify the customer's proof of payment. In one embodiment, the customer may only be charged if an advertisement is delivered to a target user.

An auction may include a series of individual sales or deliveries of goods or commodities such as advertisements delivered in available slots by a delivery network, each resulting in a charge to the customer. The bid price may be the maximum price the customer may pay for such a delivery, and each individual sale may be at some price at or below the bid price. In one embodiment, the customer with a higher bid for an available slot may be charged an increment of money more than the customer with the next highest bid for that slot. In such an embodiment, each advertisement delivered to a user in a slot in a delivery network may cost the customer a different amount, which may depend on auction competition. In another embodiment, a customer may be charged the amount of money that he bids.

Customers that bid on overlapping slots in a delivery network (e.g., in which goods or commodities may be delivered to targeted users), for example, all customers that select sets of parameters that describe overlapping subsets of available slots, may enter a series of auctions that may allocate the subsets of available slots. In one embodiment, customer goods such as advertisements may be delivered in advertisement slots allocated to the customer, at auction, by a delivery network, to users who enter information into user information fields 112 and have usage information that fall within the range of the target user information 122 the customer selects.

In one embodiment, every person that bids may be considered a separate customer. Customers may compete with other customers who select substantially similar target user options 122 and usage information. For example, customers who select overlapping programs and time slots and similar target users are targeting overlapping groups of users. The bid price for a customer to win an advertisement delivery or slot may depend on competing customer bids. The bid price for a customer to win an advertisement slot in a delivery network during which the customer's advertisement may be delivered to a target user may also depend on other factors, for example, customer selected information fields 125, the content and design of the advertisement, for example, advertisement length, advertisement components (e.g., music, text, video, etc.), broadcast times, media type (e.g., Internet radio, Internet television, terrestrial media, etc.) or other factors.

In one embodiment, customers may bid for or place an advertisement at any point in time, up to when the auction is closed. An auction may close at some set time, for example, when the program or broadcast period for an available slot that an auction is conducted for begins to broadcast.

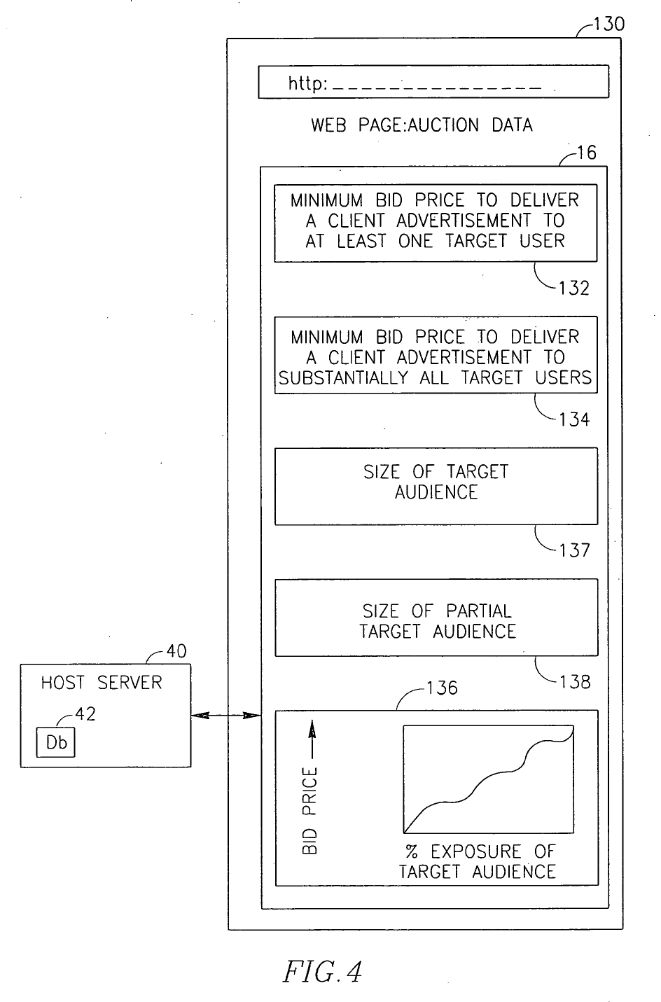

FIG. 4 schematically illustrates a web page with a graphical user interface providing predicted data, and its interaction with other components, according to one embodiment of the present invention. In system 1, host server 40 may accept customer input data such as target user information 122 and/or auction information 126 (e.g., a specific bid for a specific campaign), via customer GUI 16, and may generate output data such as predicted data 135.

In one embodiment a subset of target users may be defined as a set of potential (as opposed to actual) users of system 1, such as listeners of a media stream, which are defined by descriptive, personal, or demographic data and in addition by usage data, such as when and to which media streams the users actually or are predicted to listen. For example, a subset of users may be women aged 49-65 in the State of Illinois who are predicted to listen to a certain Internet radio station during the hours of 6 p.m. to 9 p.m. on Tuesdays.

Predicted data 135 may be displayed on one or more customer GUI 16 screens that may be viewed on one or more web pages 130. Predicted data 135 may or may not match actual bid data.

Predicted data 135 may include the estimated minimum bid price to deliver a customer advertisement (or any customer good or commodity) to at least one target user 132 (e.g., the minimum bid price to win or be allocated an available slot in a delivery network that is predicted to be delivered to at least one target user), the estimated minimum bid price to deliver a customer advertisement to substantially all target users 134, the estimated minimum bid price to deliver a customer advertisement to a range of percentages of target users or other suitable predicted data 135. Predicted data 135 may be presented as a graphic representation 136. Predicted data 135 may include the estimated size of a target audience 137, or an estimate of how many current users fall within the target user range the customer selects (e.g., users who match target demographic and usage information). Predicted data 135 may include an estimate of the size of the partial target audience 138 that may be exposed to customer advertisements (e.g., in an available slot allocated at auction) for a certain bid price and may include recommended bid adjustments for customers to get desired predicted auction results.

Host server 40 may input a bid price and the selected set of parameters and estimate the number of available slots described by those parameters in a delivery network (e.g., advertisement slots during which customer advertisements may be delivered to target users) that may be allocated to a customer at auction using the price. For example, for a specific bid price, host server 40 may estimate the size of the partial target audience or the number of target users to which the delivery network may deliver a customer's advertisement in an available slot allocated to the customer at auction using the bid price. Predicted data 135 may include the relationship between a set or range of bid prices and an estimated number of available slots in a delivery network that may be allocated to a customer at auction using the prices.

Predicted data 135 may provide customers with predictions or suggestions for selecting a bid price to win available slots with which goods or commodities such as advertisements may be delivered to a subset of target users. In one embodiment, if a customer inputs specific target user information 122 and possibly auction information 126 via customer GUI 16 on web page 120, host server 40 may output predicted data 135 via customer GUI 16 on web page 130. Host server 40 may output predicted data 135 automatically or at the customer's request. On web page 120, customer GUI 16 may provide an optional calculate button 130 that a customer may select (e.g., by clicking) to request predicted data 135.

Host server 40 may record past user data or data that relates to past users to whom advertisements were delivered. For example, each individual advertisement delivery to the user, the user information 112 and the usage data relevant to the sale or delivery may be recorded. A derivation of such data may be stored for storage or privacy reasons. Host server 40 may determine which advertisements were delivered to users by recording user access of advertisements. Host server 40 may use past results of advertisement delivery to target user to generate expectations for current or future delivery of advertisements to target user (e.g., predicted data 135). The sample group may be a subset of all relevant past users randomly selected or selected by any suitable method.

To generate predicted data 135 for a customer, host server 40 may input (1) past user data (filtered to fit to the demographic and usage data of the current customer) (2) the customer's bid and (3) current bids from other customers who select overlapping parameters.

Host server 40 may accept sets of parameters that customers may select (e.g., by choosing customer selection information fields 125) that describe a subset of available slots in a delivery network, for example, that may be used to deliver advertisements to a subset of target users. Host server 40 may input past user data, which may include recorded exposure data that relates to a sample group of past users who have usage information and enter information into user information fields 112 that falls within the range of the customer's selected parameters. Host server 40 may input current competing customer bids, for example, current customer bids for overlapping available advertisement slots and may simulate an auction for those advertisement slots. Host server 40 may take each of the sampled past target users and using a simple of current customer bids for advertisements directed at such users host server 40 may generate an advertisement sequence. Host server 40 may generate advertisement sequences, using current customer bid data (e.g., advertisements may be ordered by bid price). Based on recorded past target user exposure or delivery data, host server 40 may determine which advertisements in the advertisement sequences were delivered to target users and at what price. For example, host server 40 may estimate if a customer's advertisement would be delivered to a past target user with a specific bid price if the customer was competing against current bids for overlapping advertisement slots. A customer may be provided with an estimation of a minimum price he may be required to bid to win or be allocated an available slot in a delivery network that may be used to deliver a good or commodity such as a customer advertisement to a predefined minimum number of target users.

In one embodiment, a customer may bid to be allocated a series of desired slots in a delivery network. The customer bid may correspond to a set of user parameters (e.g., including target user information 122) that may describe a targeted user (e.g., selected by the customer) and/or available slots in a delivery network. Host server 40 may accept the customer bid and simulate an auction. Host server 40 may compare or order the customer bid with other current customer bids (e.g., corresponding to matching or similar sets of user parameters). Host server 40 may sample (e.g., from a database) a set of past sales that may correspond to the set of user parameters. Each past sale (e.g., recorded from past auctions) may include or correspond to a sale price. Host server 40 may determine an estimated number of sales that may result from the customer bid. Host server 40 may provide a minimum price, where if host server 40 accepts a customer bid that is at least the minimum price, a predefined minimum number of sales are estimated to be purchased.

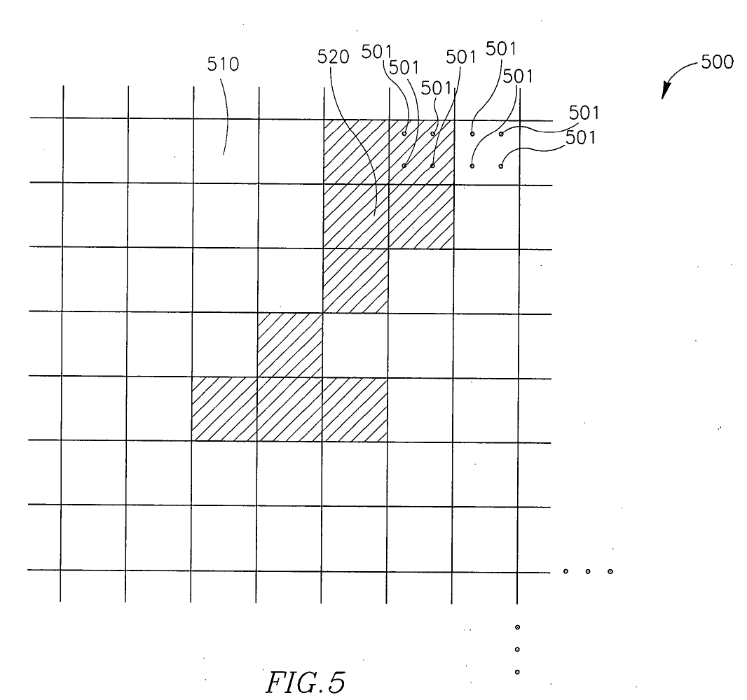

In one embodiment, a matrix or grid may be used to store past user data. FIG. 5 schematically represents a matrix that includes user option ranges, in accordance with an embodiment of the present invention.

Matrix 500 stores past user points 501, which may be for example individual instances of available slot in a delivery network sold at auction. For example, each point 501 may be a target user hit, individual instance of an advertisement being delivered to a specific user at a specific time, for a specific media stream. In another embodiment, each point 501 in matrix 500 may include a frequency or metered tally of target user hits associated with a specific user. Specific user data, for example, an identification number, may be stored with point 501. In another embodiment, only general demographic data may be stored with point 501, so a user may be anonymous.

Matrix 500 may include cells 510. Each cell 510 may store or be associated with a set of one or more specific points 501, available slots in a delivery network or any suitable set of past data. Each cell 510 may be defined by a set of parameters that may describe a subset of available slots in a delivery network that may be allocated at auction, for example, a subset of customer selection information fields 125 such as user demographic options and customer usage information. For example, a cell 510 may be associated with sample users who are women, between the ages of 45 and 47 that live in Queens, N.Y. and listen to a “talk radio” program, broadcast 5-6 p.m. on Fridays. Each cell 510 may include all points 501 (e.g., exposed users) that fit the set of parameters associated with that cell 510. Each cell 510 may be substantially distinct, such that no two cells 510 have precisely the same range of user information. While matrix 500 as shown in FIG. 5 is two-dimensional, the matrix may have many dimensions, each corresponding to a category of user, demographic, or usage information. For example, dimensions may include zip or postal code, gender, age category, media stream accessed or media category accessed, hour or time range the media stream is accessed. In one embodiment, one matrix 500 is recorded for each of a number of past days; e.g., seven matrices are recorded for each day of the past week; however the date may be integrated with the time as a dimension.

A target user array 520 (indicated by cross hatching) may be associated with a set of parameters or customer selection information fields 125 selected by a customer, for example, target user information 122, and may contain a group of points 501 or advertisement delivery information relating to users a customer wishes to reach with an advertising campaign (e.g., target users). Target user array 520 may include all cells 510 of matrix 500 associated with selected points 501 that relate to target users associated with selected target user options 122.

A customer with a specific bid price or campaign data may compete against customers with current bid data, who may have selected overlapping sets of parameters or which describe overlapping slots in a delivery network. For example, host server 40 may estimate if a user corresponding to a point 501 would be exposed to a customer's advertisement with a specific bid price if the customer was competing at an auction against current bids.

Host server 40 may use patterns of the delivery of customer goods to past target users to estimate current or future patterns of the delivery of customer goods. Host server 40 may use past user data stored (e.g., patterns of past target user exposure to certain time or broadcast slots) in target array 520 that match a customer's selected information 122.

Each point 501 in the target user array 520 may, for example, indicate past target users who accessed slots in the past that may be substantially similar to the slots allocated to the customer in the simulated auction. Host server 40 may estimate the delivery of a customer advertisement to current target users by measuring the number or frequency of such points 501 in the target user array.

Since the number of possible cells 510 and points 501 may be quite large, to provide an estimate of auction results, a sample or subset of points 501 may be selected. Sample points or users may be selected randomly, or according to a method or algorithm, from among points 501 or advertisement deliveries recorded by host server 40. For example, cell 510 including points 501 may indicate that a user having specific demographic information received an advertisement in a media stream while listening to a certain program or media stream at a certain time and date. More than one such point 501 may be in each cell 510. A sample group may include a variety or even distribution of points 501.

To further increase computational efficiency, since the number, of current customer bids competing for the same or overlapping slots may be quite large, to generate predicted data for a customer, host server 40 may input a sample or subset of current customer bid from among all current competing customer bids. The sample of current customer bid may be selected at random or by any suitable manner.

The granularity of cells 510 may correspond to a program, station and/or time slot. For example, the granularity of cells 510 may correspond to the duration of full program blocks and/or one hour time slots. A point 501 or user hit may relate to users that tuned into to the program and/or time slot. In one embodiment, users who tuned into to a program at any time within a time slot may be assumed to be tuned in for the full duration of the program and/or time slot and may be assumed to have been exposed to all advertisements that may be broadcast during that program and/or time slot. For example, if a user tuned into to a program A, from 1:32 p.m.-1:48 p.m., the user may correspond to a point 501 in cell 510 that relates to program A, from 1 p.m.-2 p.m.

Associated with each program and/or time slot represented in a cell 510 is a predetermined amount of advertisement time, during which advertisements may be integrated into programs or media streams. Based on the results of a series of simulated auctions for available slots in a delivery network targeted at a series of groups of target users, a sequence of available slots may be allocated to some customers competing in the series of auctions according to current bid competition or other factors.

Typically, the customer with the lowest bid is allocated the slot with the lowest priority position in the sequence (e.g., the last of available slots in the sequence to broadcast for a broadcast cycle).

Host server 40 may calculate the lowest bid from among customers who were allocated a slot in the sequence of available slots, which may be the estimated lowest price a customer is required to bid to deliver an advertisement to a past target user associated with each point 501. The lowest price may be different for each point 501, as it may be associated with a distinct user demographic range and a distinct group of competitors at auction. Host server 40 may output the smallest of the lowest prices for selected sample points 501 and may report this value as the estimated minimum bid price to deliver a customer advertisement to at least one target user 132. The largest of the lowest prices for the selected sample points 501 in target user array 520 may be the estimated minimum bid price to deliver a customer advertisement to substantially all target users 134. The total number of points 501 associated with customer selection information fields 125 for a corresponding program and time window as recorded for a past period (e.g., the past week) may be presented. This may include multiple hits for each point 501, and may be reported as the estimated size of a target audience 137.

Host server 40 may input customer selected information fields 125 and may also input a bid price and may output an estimate of the size of a partial target audience 138 to whom customer advertisements may be delivered with that bid (e.g., where the estimation may be based on a simulated auction using current customer bids). To compute the partial target audience 138, host server 40 may tally an omitted target audience or points 501 that are not reached with a bid price below the estimated minimum bid price to deliver customer advertisement to at least one target user 132. Host server 40 may deduct the estimated size of the omitted target audience from the estimated size of a target audience 137 to output the estimated size of the partial target audience 138.

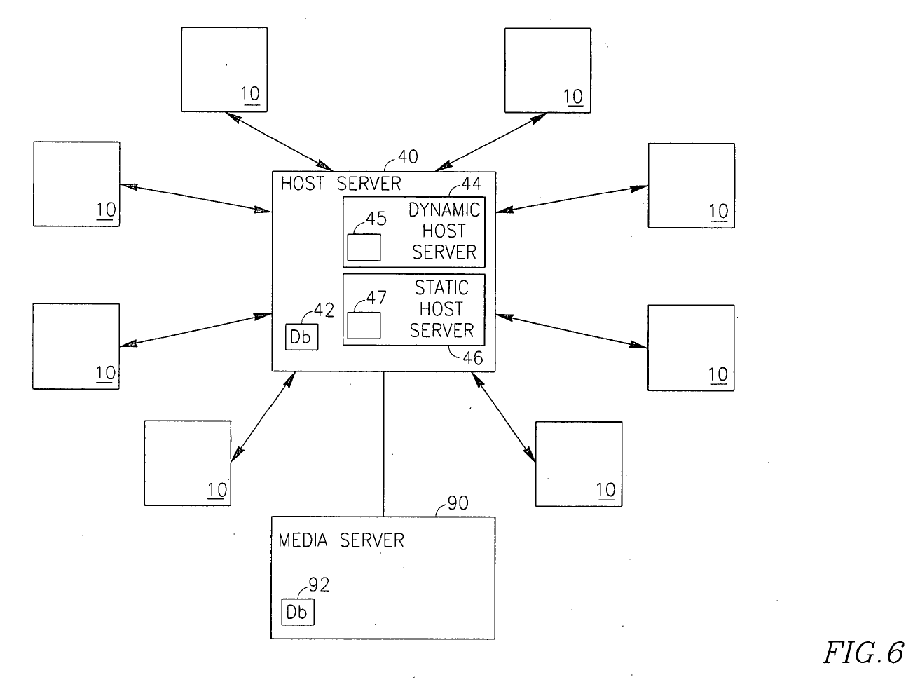

FIG. 6 schematically represents an exemplary online auction system, including a host server to compute and store auction data and two or more customer computers that may be used to compete in a series of online auction, in accordance with some embodiments of the invention. Customers may compete with other customers who are bidding on substantially similar available slots in a delivery network, for example, directed at substantially similar target users. The price required to win an advertisement slot may depend on competing customer bids and/or other factors.

Selecting customer selection information fields 125 may result in overlapping target used sets and bidding via customer GUI 16. Host server 40 may accept customer selection information fields 125 from one or more customers (e.g., via one or more customer computers 10). Results for a series of auctions may include, for example, determining which customers have won which auctions and with what priority the customer has won. In one embodiment, in a series of auctions customers may bid on a specific range of slots in a delivery network, for example, advertisement slots, that may be available or delivered to a specific range of target users. Host server 40 may compile the result for the series of auctions. A customer with a higher bid relative to another customer may be allocated a slot with greater priority in placement, frequency or arrangement, relative to the slot allocated to the relatively lower bidder. An advertisement sequence of customer advertisements may be assembled according to the allocation of slots to customers. The advertisement sequence may be stored (e.g., in a cache unit or other area on a local user computer) and integrated into a media broadcast in advertisement pods that may be delivered to any of the target users, upon user access of the media broadcast. Such an advertisement sequence may include advertisements from all customers that won or were allocated slots in the series of auctions.

Customers may be charged for advertisements successfully delivered to target users. The host server may keep a metered tally of such deliveries. For example, if a user signs off early or signs on late within a time block and only certain advertisements are delivered to the user, typically only those customers whose advertisements are delivered to the user are charged. In one embodiment, the customer who wins an auction with a higher bid for a slot may be charged an increment of money (e.g., $0.01 or $1 or some set or variable amount of money) more than the customer with the next highest bid for that slot instead of the customer's actual bid. In another embodiment, a customer may be charged the amount of money that the customer bid.

Customer bids may be weighted or normalized. In one embodiment, a customer's bid may be weighted for each time unit of the duration of the customer's advertisement, for example, for each unit of an available slot, for example, each second of an advertisement pod or slot. In one embodiment, customers may bid for a subset of available slots in a delivery network with respect to a length of time. Thus, for substantially similar bids, a customer with a longer advertisement who may compete for longer slots may be charged more for each slot that would a customer with a shorter advertisement who may compete for shorter slots. In one embodiment, host server 40 may include a dynamic server 44 to execute dynamic auction functions, for example, generating auction results, computing predicted data 135, accepting customer and user data etc., and a separate static server 46 to store the auction results generated by dynamic server 44.

Dynamic server 44 may include a database 45. Static server 46 may include a database 47. Dynamic server 44 may input and output data from and to customers, users, media providers and other suitable sources, generate auction results, including advertisement sequences that may be integrated into a media stream, and may send the results to be stored in static server 46. System 1 components or mechanisms, for example, media server 90, which may integrate the appropriate advertisement sequence into available slots in advertisement pods in a media stream broadcast, may access the appropriate advertisement sequence from storage in static server 46 when needed.

Dynamic server 44 may generate and/or compute auction results at the close of the auction or throughout the duration of the auction, for example, substantially every time a new customer bids. Dynamic server 44 may generate the results of the auctions, for example, when the auctions are closed. In one embodiment, auctions may be closed prior to the time when the delivery network delivers customer goods such as advertisements, for example, at a set time prior to when the deliveries may be made. Allocated slots in a delivery network, advertisement sequences or a list of advertisement sequences or codes or advertisement units that indicate the advertisements that may be delivered, may be stored, for example, in static server 46 or on local user computers and may be ready for delivery (e.g., to local user computers 20) prior to the time of the allocated slot(s), for example, when a user accesses a media player, a broadcast or station or an advertisement pod. Advertisement sequences targeted at specific target users may be stored, for example, on local user computers 20 of specifically targeted users prior to the time of delivery. Advertisements may be delivered in allocated slots in advertisement pod segments of media streams by the delivery network to the target users, if the target user accesses the appropriate slots. Advertisements or portions of advertisement sequences broadcast to target users in advertisement pods may reported (e.g., by an advertisement agent or local computer 20) to host server 40. Host server 40 may charge customers whose advertisements were delivered to target users according to embodiments of the present invention. Deliveries of customer goods to users may be recorded according to embodiments of the present invention. In other embodiments, advertisement sequences may be stored, for example, in static server 46, media server 90 or any other suitable location. The advertisement sequence may be integrated into the appropriate slots of a delivery network, for example, a radio broadcast network, by host server 40, media server 90, or by media server 90 and host server 40, such that the servers may coordinate media broadcasts and customer advertisement broadcasts, respectively. The media broadcast with integrated customer advertisements may be broadcast to target users via Media GUI 18. Other components or configurations may be used.

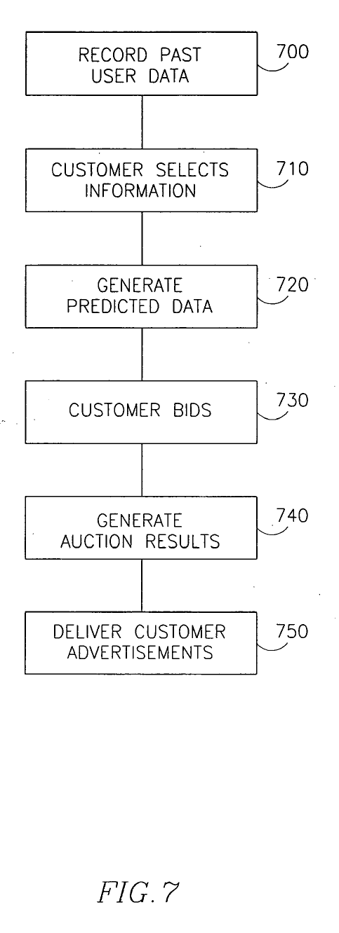

FIG. 7 is a flowchart of a method according to one embodiment of the present invention.

In operation 700, a host server may record past user data. Host server 40 may record past user data or data that relates to past users to whom customer goods (e.g., advertisements) are delivered. Each individual advertisement delivery to the user, user information and usage data relevant to the sale, may be recorded. The host server may also store a derivation of such data, for storage or privacy reasons. The host server may store auction data for various auctions selling various goods, for example, available slots in a delivery network that may be used to deliver customer advertisements to target users. Auction data may be stored in a matrix or histogram.

In operation 710 customers may select information, for example, via a client graphical user interface. In one embodiment, auctioning a set of goods may include a first customer selecting a first set of parameters describing a first subset of slots in a delivery network and a second customer selecting a second set of parameters describing a second subset of slots in a delivery network. The host server may accept the first and second sets of parameters and, if the first and second subsets of slots in a delivery network overlap, the host server may auction a series of available slots in a delivery network that may include slots in the overlapping subset. Using the first and second sets of parameters, the host server may conduct a series of auctions for a series of available slots in a delivery network, which may include the available slots of the first and second subsets of slots in a delivery network that the sets of parameters describe. Other numbers of customers may participate, resulting in multiple overlapping sets of slots in a delivery network.

The first and second set of parameters may include auction information, target user information, requests for predicted data, bidding information and other suitable information.

Auction information may include a range of desired advertising campaign options, for example, a potential bid price or bid price range, including an estimated minimum and maximum bid price for each advertisement delivery, cost of the advertisement campaign per prior of time, total cost of advertisement campaign, campaign duration, dates, etc. Other options may be provided.

Target user information may include, for example, desired demographics, locations of residence and/or employment, zip code, age, income level, and any other suitable user information. In addition, target user information may include a desired number of exposed target users and usage information such as radio stations or categories of radio stations selected, time and day of use, the approximate time of broadcast, broadcast programs, etc. for the customer advertisement broadcast. Target user information may include undisclosed or additional user information, for example, the time a user is operating a streaming media GUI, the type of streaming media requested, the user's most frequently viewed programs or the times of day the user views programs. Other options may be provided.

The customer may control the content and design of the advertisement that may be played in an advertisement slot in a delivery network won at auction. In one embodiment, the customer may use tools to create or upload an advertisement. The customer may, for example, select the type(s) of streaming media with which the customer advertisement may be broadcast (e.g., internet radio, internet television, terrestrial media, etc.) advertisement format (e.g., only text, streaming banner, audio and/or visual with optional text, images or image streams, text-to speech talking head technology, etc., one or more music tracts and/or one or more jingle/sound effect tracks with variable play time, volume, etc.). The customer may use a computer to upload or access advertisements or advertisement tools from a host database or from another suitable source, for example, a computer memory, an additional server and/or external device, such as, a music storage device. Advertisement size and content may affect auction/bid price per advertisement exposure.

In operation 720, the host server may generate predicted data. The host server may perform a simulated auction of a series of available slots in a delivery network and provide predicted data including estimated results of the auction. The predicted data may provide customers with predictions, suggestions or estimations for selecting a bid price to win available slots in a series of auctions that may be delivered to a desired range of target users.

The host server may input data recorded at a previous time, for example, stored in a matrix such as a sample of past user data stored in operation 700, that relates to advertisement delivery for a sample group or subset of past target users, who match parameters the customer selected for auction. The host server may simulate a series of auctions to allocate available slots for customer advertisements or generate advertisement sequences, using current customer bid data (e.g., slots may be allocated in order of bid price). Based on recorded past target user advertisement delivery data, the host server may determine which advertisements in the advertisement sequences were delivered to target users and at what price.

The host server may estimate if a customer advertisement with a specific bid price would be delivered to a sampled past target user if the customer was competing against current bids for overlapping available advertisement slots. A customer may be provided with an estimation of a minimum price the customer may be required to bid at auction to purchase a predefined minimum number of available slots in a delivery network, for example, that may be delivered to target users.

The host server may determine a subset of past target users who were exposed to substantially similar slots in a delivery network, won at past auctions with substantially similar bid prices.

Predicted data may be displayed to the customer on a graphical user interface, and may or may not match actual auction results. Operation 720 may be executed optionally, automatically and/or at the customer's request.

In operation 730, the customer may bid on one or more available slots in a delivery network. The customer may generate a bid price or verify auction information selected in operation 710, for example, by selecting a bid command that may be displayed on the graphical user interface. Subject to verification, for example, of proof of payment or advertisement content, etc., the customer may compete at auction for an available advertisement slot according to the customer options selected in operation 710.

In operation 740, the host server may generate auction results. Host server may accept bids selected in operation 730 from one or more customers competing in a series of auctions. Customers may compete with other customers who select substantially similar customer selection information in operation 710, for example, customers who bid on substantially similar slots in a delivery network, for example, advertisement slots directed at substantially similar target users. Since each customer may define different subsets of users and usage data, auctions take place over individual users listening at specific times, and in each auction a different set of customers may compete. Since matrix cells represent every combination of user and usage parameters from which the customer may select, there may potentially be as many auctions as there are matrix cells. The host server may compile allocated slots according to auction results, integrate customer advertisements for customers who were allocated slots in the series of auctions and assemble or generate an advertisement sequence for each matrix cells or user whose parameters match the parameters associated with each matrix cell. Advertisement sequences directed at target users may be stored in a host server, on local user computers and/or in other storage locations. The host server may generate the results of the series of auctions which may include, for example, which customers have won the auction and with what priority each customer has won. In one embodiment, a host server may compile the results of the series of auctions and may assemble advertisement sequences that may be broadcast that may be directed toward target users. In one embodiment, auctions may be closed and auction results may be generated prior to the time when the auctions'results are broadcast, for example, at a set time prior to when the auctions' results are broadcast. Advertisement sequences may include advertisements from substantially all customers who were allocated slots in the delivery network. Priority of the placement, frequency or arrangement, of the slot allocated to one customer relative to another, may be given to the customer with the higher bid relative to the other.

In operation 750, host server may deliver customer advertisements to target users. The advertisement sequence may be assembled, for example, in operation 740. Advertisement sequences directed at specific target users stored, for example, in cache units on local user computers and may be ready for delivery or insertion into a broadcast or media stream, for example, in an appropriate advertisement pod, prior to the time of broadcast. Customer advertisements may only be delivered to target users who disclosed information that substantially falls within the range of target user information the customer selects in operation 710. Advertisement sequences specifically generated for one or more target users may be stored on each target user's local computer and may be ready for delivery during the appropriate advertisement slot or pod. Advertisement may be delivered to target users, if the target users access the appropriate advertisement slots or pods.

Customer goods in slots allocated to customers at auction may be available for delivery to target users that access the delivery network, for example, user who view or listen to the streaming media, for example, by accessing the appropriate advertisement pods, via a media graphical user interface, with advertisements according to the results of the auctions generated in operation 740. Local computers may report to the host server which customer advertisements, which portions of the advertisement sequences or which advertisement pods were accessed or delivered to target users.

The host server may charge customers whose advertisements were delivered to target users according to embodiments of the present invention. The host server may keep a metered tally of such deliveries. For example, if a user signs off early or signs on late to a broadcast and only certain advertisements in certain slots are delivered to the user, typically only those customers whose advertisements are delivered to the user are charged.

Other operations or series of operations may be used.

It will be appreciated by persons skilled in the art that the present invention is not limited to what has been particularly shown and described hereinabove. Rather the scope of the present invention is defined only by the claims, which follow:

1-16. (canceled)

17. A method of distributing advertisements to a plurality of users receiving media streams, the method comprising:
accepting a plurality of bids, each bid corresponding to a set of user parameters, and each bid corresponding to an advertisement; and
for each user, creating a sequence of advertisements, wherein each advertisement in the sequence corresponds to a set of user parameters describing the user, the sequence ordered by the amount of the bid.

18. The method of claim 17, wherein each set of user parameters corresponds to a set of available slots in a delivery network.

19. The method of claim 18 comprising charging a customer for the delivery of an advertisement when a user is exposed to the advertisement in a sequence.

20. The method of claim 17 comprising delivering the sequence of advertisements to the user in available slots in a delivery network.

21. A method of distributing advertisements to a plurality of users receiving media streams, the method comprising:
accepting a plurality of bids, each bid corresponding to a set of user parameters, and each bid corresponding to an advertisement; and
for each user, transmitting only those advertisements to the user which correspond to a set of user parameters describing the user, wherein advertisements corresponding to higher bid prices are transmitted earlier than advertisements corresponding to lower bid process.

22. The method of claim 21, wherein each set of user parameters corresponds to available slots in a delivery network.

23. The method of claim 22 comprising transmitting only those advertisement corresponding to a user's usage information.

24. The method of claim 21 comprising delivering the transmitted advertisements to the user in available slots in a delivery network.

25-35. (canceled)

36. A system for distributing advertisements to a plurality of users receiving media streams, the system comprising:
a server a database, the database comprising user information, the server to:
accept a plurality of bids, each bid corresponding to a set of user parameters, and each bid corresponding to an advertisement; and
for each user, create a sequence of advertisements, wherein each advertisement in the sequence corresponds to a set of user parameters describing the user, the sequence ordered by the amount of the bid.

37. The system of claim 36, wherein each set of user parameters corresponds to a set of available slots in a delivery network.

38. The system of claim 36 wherein the server is to charge a customer for the delivery of an advertisement when a user is exposed to the advertisement in a sequence.

39. The system of claim 36 wherein the server is to deliver the sequence of advertisements to the user in available slots in a delivery network.

40. A system of distributing advertisements to a plurality of users receiving media streams, the system comprising:
a server comprising a database, the database comprising user information, the server to:
accept a plurality of bids, each bid corresponding to a set of user parameters, and each bid corresponding to an advertisement; and
for each user, transmit only those advertisements to the user which correspond to a set of user parameters describing the user, wherein advertisements corresponding to higher bid prices are transmitted earlier than advertisements corresponding to lower bid process.

41. The system of claim 40, wherein each set of user parameters corresponds to available slots in a delivery network.

42. The system of claim 40 wherein the server is to transmit only those advertisement corresponding to a user's usage information.

43. The system of claim 40 wherein the server is to deliver the transmitted advertisements to the user in available slots in a delivery network.
